(19) United States
(12) Patent Application Publication
(10) Pub. No.: US 2022/0083374 A1
(43) Pub. Date: Mar. 17, 2022

(54) METHOD FOR PROCESSING DATA, TASK PROCESSING SYSTEM AND ELECTRONIC EQUIPMENT

(71) Applicant: HUAKONG TSINGJIAO INFORMATION SCIENCE (BEIJING) LIMITED, Beijing (CN)

(72) Inventors: Hu LI, Beijing (CN); Le SU, Beijing (CN)

(21) Appl. No.: 17/444,574

(22) Filed: Aug. 6, 2021

(30) Foreign Application Priority Data
Sep. 11, 2020 (CN) 202010955866.3

(51) Int. Cl. G06F 9/48; G06F 9/50; G06F 16/901

(52) U.S. Cl. CPC G06F 9/4881; G06F 16/9024; G06F 9/5027

(57) ABSTRACT

A method for processing data, task processing system and electronic equipment are disclosed. The method includes: receiving a computation request sent by task requesting party; parsing a computation task corresponding to the computation request, identifying a target data providing party involved in the computation task, identifying a computation engine required for the computation task; sending the computation task to the ciphertext computation engine for computation when the computation engine required for computation task is the ciphertext computation engine; sending the computation task to a plaintext computation engine for computation when the computation engine required for computation task is the plaintext computation engine; sending the computation task to the plaintext and ciphertext computation engine for computation and data interaction when computation engines required for computation task are the plaintext and ciphertext computation engine; determining a computation result corresponding to the computation request and sending the result to the result demanding party.

### RELATED APPLICATION

The present application claims the priority to Chinese Patent Application No.: 202010955866.3, filed Sep. 11, 2020, the content of which is hereby incorporated herein by reference in its entirety.

### TECHNICAL FIELD

The present disclosure relates to the field of data processing, in particular to a method for processing data, a task processing system and an electronic equipment.

### BACKGROUND

Secure multi-party computation is for the non-trusted third party, the secure multi-party computation can achieve the computation and fusion of data among a plurality of non-trusted databases when keeping the data private mutually. Currently, multiple computation nodes are set in the secure multi-party computation. The computation node obtains the ciphertext of private data from the data party, and performs computation based on the ciphertext, thus the plaintext of the computation result can only be acquired by the result party. Since the computation node obtains the ciphertext of the private data and does not know the real data, the computation and fusion of data can be achieved while keeping the data private.

Since the secure multi-party computation system performs computation based on the ciphertext, the computational efficiency is low, how to improve the efficiency of the secure multi-party computation system is a problem to be urgently solved.

### SUMMARY

The present application discloses a method for processing data, the computational efficiency can be improved through the method.

The present application also discloses an apparatus configured to process data, a task processing system and an electronic equipment, the apparatus, system and electronic equipment is used to perform the method for processing data mentioned above.

Specifically, the present application discloses a method for processing data, the method is used in a task processing system, wherein the task processing system comprises a task processing platform, a task requesting party, a data providing party, and a result demanding party; the task processing platform is provided with a ciphertext computation engine, the data providing party being provided with a plaintext computation engine, and the method comprises the following steps: receiving, by the task processing platform, a computation request sent by the task requesting party; parsing a computation task corresponding to the computation request, identifying a target data providing party involved in the computation task, and identifying a computation engine required for the computation task; wherein at least one target data providing party is available; sending the computation task to the ciphertext computation engine for computation when the computation engine required for the computation task is the ciphertext computation engine; sending the computation task to a plaintext computation engine provided in the target data providing party for computation when the computation engine required for the computation task is the plaintext computation engine provided in the target data providing party; sending the computation task to the plaintext computation engine and the ciphertext computation engine for computation and data interaction when computation engines required for the computation task are the plaintext computation engine provided in the target data providing party and the ciphertext computation engine; and determining a computation result corresponding to the computation request based on a computation result corresponding to the computation engine required for the computation task, and sending the computation result corresponding to the computation request to the result demanding party.

In an embodiment, the step of parsing a computation task corresponding to the computation request, identifying a target data providing party involved in the computation task, and identifying a computation engine required for the computation task comprises the following steps: determining a computational logic and a computational configuration based on the computation request; and identifying, based on the computational logic and computational configuration, the computation task, the target data providing party involved in the computation task, and the computation engine required for the computation task.

In an embodiment, the step of identifying the computation task based on the computational logic and computational configuration comprises: parsing based on the computational logic and the computational configuration to generate a computational graph, wherein, the computational graph comprises a node and an edge connecting the nodes, the node is corresponding to a variable in the computational logic, and the edge is corresponding to an operation in the computational logic; and generating the computation task based on the computational graph.

In an embodiment, the computational configuration contains a data providing party ID involved in the computation task, and the step of identifying a target data providing party involved in the computation task and identifying a computation engine required for the computation task comprises: in the case that the computational configuration contains one data providing party ID, identifying the target data providing party according to the data providing party ID, and identifying that the computation engine required for the computation task is a local plaintext computation engine of the target data providing party; and in the case that the computational configuration contains a plurality of data providing party IDs, identifying a plurality of target data providing parties according to the data providing party IDs, and identifying the computation engine required for the computation task according to the computational logic.

In an embodiment, the step of identifying the computation engine required for the computation task according to the computational logic comprises: if determining, based on the computational logic, that an operation involved in the computation task is for data of a single target data providing party, identifying that the computation engine required for the computation task is the plaintext computation engine; if not, identifying that the computation engine required for the computation task is the ciphertext computation engine.

In an embodiment, an input parameter for each group of computation in the computational logic has a preset identification, and the preset identification comprises a plaintext identification or a ciphertext identification; the method further comprises: adding the plaintext identification to corresponding node in the computational graph based on the plaintext identification of the input parameter for each group of computation, and adding the ciphertext identification to corresponding node in the computational graph based on the ciphertext identification of the input parameter for each group of computation; the step of generating the computation task based on the computational graph comprises: determining the computation task based on the preset identification of the node and an edge associated with the node in the computational graph, wherein the computation task comprises: a plaintext computation task and/or a ciphertext computation task; the step of identifying the computation engine required for the computation task comprises: in the case that the computation task comprises the plaintext computation task, identifying that the computation engine required for the computation task is the plaintext computation engine; in the case that the computation task comprises the ciphertext computation task, identifying that the computation engine required for the computation task is the ciphertext computation engine; and in the case that the computation task comprises the plaintext computation task and the ciphertext computation task, identifying that the computation engines required for the computation task are the plaintext computation engine and the ciphertext computation engine.

The present application discloses an apparatus configured to process data, the apparatus is used in a task processing system, wherein the task processing system comprises a task processing platform, a task requesting party, a data providing party, and a result demanding party; the task processing platform is provided with a ciphertext computation engine, the data providing party being provided with a plaintext computation engine, and the apparatus is deployed on the task processing platform, the apparatus comprises: receiving module, configured to receive a computation request sent by the task requesting party; parsing and identifying module, configured to parse a computation task corresponding to the computation request, identify a target data providing party involved in the computation task, and identify a computation engine required for the computation task; wherein at least one target data providing party is available; a first computation task sending module, configured to send the computation task to the ciphertext computation engine for computation when the computation engine required for the computation task is the ciphertext computation engine; a second computation task sending module, configured to send the computation task to a plaintext computation engine provided in the target data providing party for computation when the computation engine required for the computation task is the plaintext computation engine provided in the target data providing party; a third computation task sending module, configured to send the computation task to the plaintext computation engine and the ciphertext computation engine for computation and data interaction when computation engines required for the computation task are the plaintext computation engine provided in the target data providing party and the ciphertext computation engine; and a returning module, configured to determine a computation result corresponding to the computation request based on a computation result corresponding to the computation engine required for the computation task, and send the computation result corresponding to the computation request to the result demanding party.

In an embodiment, the parsing and identifying module comprises: a determination submodule, configured to determine a computational logic and a computational configuration based on the computation request; and an identification submodule, configured to identify, based on the computational logic and computational configuration, the computation task, the target data providing party involved in the computation task, and the computation engine required for the computation task.

In an embodiment, the determination submodule comprises: a computational graph generation unit, configured to parse based on the computational logic and the computational configuration to generate a computational graph, wherein, the computational graph comprises a node and an edge connecting the nodes, the node is corresponding to a variable in the computational logic, and the edge is corresponding to an operation in the computational logic; and a computation task generation unit, configured to generate the computation task based on the computational graph.

In an embodiment, the computational configuration contains a data providing party ID involved in the computation task, and the identification submodule comprises: a first computation engine identification unit, configured to, in the case that the computational configuration contains one data providing party ID, identify the target data providing party according to the data providing party ID, and identify that the computation engine required for the computation task is a local plaintext computation engine of the target data providing party; and a second computation engine identification unit, configured to, in the case that the computational configuration contains a plurality of data providing party IDs, identify a plurality of target data providing parties according to the data providing party IDs, and identify the computation engine required for the computation task according to the computational logic.

In an embodiment, the second computation engine identification unit is configured to, if determining, based on the computational logic, that an operation involved in the computation task is for data of a single target data providing party, identify that the computation engine required for the computation task is the plaintext computation engine; if not, identify that the computation engine required for the computation task is the ciphertext computation engine.

In an embodiment, an input parameter for each group of computation in the computational logic has a preset identification, and the preset identification comprises a plaintext identification or a ciphertext identification; the apparatus further comprises: an identification addition module, configured to add the plaintext identification to corresponding node in the computational graph based on the plaintext identification of the input parameter for each group of computation, and add the ciphertext identification to corresponding node in the computational graph based on the ciphertext identification of the input parameter for each group of computation; the computational graph generation unit is configured to determine the computation task based on the preset identification of the node and an edge associated with the node in the computational graph, wherein the computation task comprises: a plaintext computation task and/or a ciphertext computation task; the identification submodule comprises a third computation engine identification unit, configured to, in the case that the computation task comprises the plaintext computation task, identify that the computation engine required for the computation task is the plaintext computation engine; in the case that the computation task comprises the ciphertext computation task, identify that the computation engine required for the computation task is the ciphertext computation engine; and in the case that the computation task comprises the plaintext computation task and the ciphertext computation task, identify that the computation engines required for the computation task are the plaintext computation engine and the ciphertext computation engine.

The present application discloses a task processing system, comprises: a task processing platform, a task requesting party, a data providing party, and a result demanding party; the task processing platform is provided with a ciphertext computation engine, the data providing party being provided with a plaintext computation engine, wherein, the task processing platform is configured to: receive, by the task processing platform, a computation request sent by the task requesting party; parse a computation task corresponding to the computation request, identify a target data providing party involved in the computation task, and identify a computation engine required for the computation task; wherein at least one target data providing party is available; send the computation task to the ciphertext computation engine for computation when the computation engine required for the computation task is the ciphertext computation engine; send the computation task to a plaintext computation engine provided in the target data providing party for computation when the computation engine required for the computation task is the plaintext computation engine provided in the target data providing party; send the computation task to the plaintext computation engine and the ciphertext computation engine for computation and data interaction when computation engines required for the computation task are the plaintext computation engine provided in the target data providing party and the ciphertext computation engine; and determine a computation result corresponding to the computation request based on a computation result corresponding to the computation engine required for the computation task, and send the computation result corresponding to the computation request to the result demanding party.

The present application discloses an electronic equipment, comprises: one or more processors; and one or more readable media, an instruction be stored in the readable media and be configured as by one or more of processors execute for performing the method for processing data mentioned above.

The present application discloses a readable medium, when the instruction in the storage medium is executed by a processor in an electronic equipment, the electronic equipment performs the data processing method as described in one or more embodiments of the present disclosure.

In the embodiments of the present disclosure, after the task processing platform receives a computation request sent by a task requesting party, the task processing platform parses the computation task corresponding to the computation request, identity the target data providing party involved in the computation task, and identity the computation engine required by the computation task; when the computation engine required for the computation task is a ciphertext computation engine, sends the computation task to the ciphertext computation engine for computation; when the computation engine required for the computation task is a plaintext computation engine provided in the target data providing party, sends the computation task to the plaintext computation engine provided in the target data providing party for computation; when the computation engines required for the computation task are a plaintext computation engine provided in the target data providing party and a ciphertext computation engine, sends the computation task to the plaintext computation engine and the ciphertext computation engine for computation and data interaction; determines the computation result corresponding to the computation request according to the computation result corresponding to the computation engine required for the computation task, and sends the computation result corresponding to the computation request to the result demanding party. In the embodiments of the present disclosure, through determining whether the computation task can be performed by using the plaintext computation engine before performing the ciphertext computation; and sending corresponding computation task to the plaintext engine for computation when the computation task is determined to be computed using the plaintext computation engine; compared with the technical solution in which only the ciphertext computation engine is used to compute all the computation tasks, the embodiments of the present disclosure can improve computational efficiency while ensuring data security.

### BRIEF DESCRIPTION OF THE DRAWINGS

FIG. 1 is a structural schematic diagram of a task processing system in an embodiment of the present disclosure;

FIG. 2 is a flow chart of a method for processing data in an embodiment of the present disclosure;

FIG. 3a is a schematic diagram of an application framework of a task processing system in an embodiment of the present disclosure;

FIG. 3b is a flow chart of a method for processing data in another embodiment of the present disclosure;

FIG. 3c is a schematic diagram of a data processing process in an embodiment of the present disclosure;

FIG. 4 is a flow chart of a method for processing data in another embodiment of the present disclosure;

FIG. 5 is a flow chart of a ciphertext computation method in an embodiment of the present disclosure;

FIG. 6 is a structural schematic diagram of a data processing apparatus in an embodiment of the present disclosure;

FIG. 7 is a structural schematic diagram of a data processing apparatus in another embodiment of the present disclosure;

FIG. 8 is a schematic diagram of an electronic equipment configured to perform the method for processing data of the present disclosure.

### DETAILED DESCRIPTION

The present disclosure will be described below in details in combination with the accompanying drawings and embodiments.

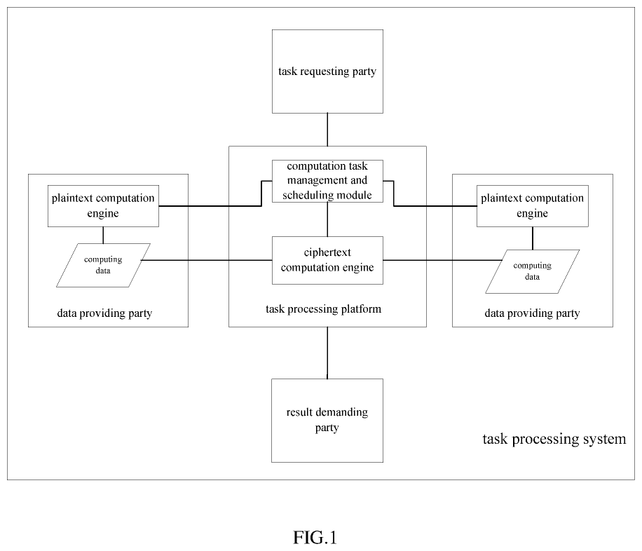

An embodiment of the present disclosure discloses a method for processing data, the data processing method is used in a task processing system, and the task processing system includes a task processing platform, a task requesting party, a data providing party and a result demanding party. Please refer to FIG. 1, which is a structural schematic diagram of a task processing system in an embodiment of the present disclosure. In an embodiment, the task requesting party includes one or more, the data providing party includes one or more, and the result demanding party also includes one or more, and FIG. 1 only shows one task requesting party, two data providing parties and one result demanding party. The task requesting party may act as a result demanding party while acting as a task requesting party; correspondingly, the result demanding party may act as a task requesting party while acting as a result demanding party. That is, the task requesting party and the result demanding party is the same. The data providing party may act as a task initiating party and/or a result demanding party while acting as a data providing party.

Wherein, the task requesting party, the data providing party and the result demanding party are referred to as participants. The task processing platform is provided in one of all the participants, or is provided in more than one participant of all the participants in a distributed manner, or is independent of all the participants, which is not limited in embodiments of the present disclosure. In an embodiment, when the task processing platforms are provided in more than one participant of all the participant in a distributed manner, the task processing platforms are managed by these participants together, and no one can decrypt the data independently, the data security can be ensured.

Wherein the data providing party is provided with a plaintext computation engine, the task processing platform is provided with a ciphertext computation engine, and a computation task management and scheduling module. In an embodiment, the ciphertext computation engine performs ciphertext computation based on secure multi-party computation protocol, the ciphertext computation includes ciphertext-only operation, and hybrid operation of plaintext and ciphertext. The computation task management and scheduling module is configured to schedule the plaintext computation engine and the ciphertext computation engine for computation. In an embodiment of the present disclosure, a hybrid computation system architecture including a plaintext computation engine and a ciphertext computation engine is constructed, the hybrid computation system architecture automatically identifies whether the required computation engine is a plaintext computation engine or a ciphertext computation engine according to the set rules when performing a computation task, such that the computation task which can be computed by the plaintext computation engine is sent to the plaintext computation engine for computation. Compared with the technical solution in which only the ciphertext computation engine is used to compute all the computation tasks, the embodiments of the present disclosure can improve computational efficiency while ensuring data security.

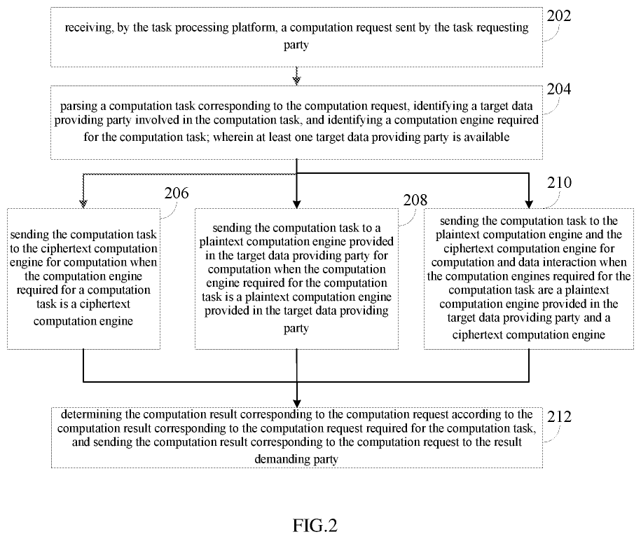

Please refer to FIG. 2 which is a flow chart of a method for processing data in an embodiment of the present disclosure, the method includes the following steps.

Step 202, receiving, by the task processing platform, a computation request sent by the task requesting party.

Step 204, parsing a computation task corresponding to the computation request, identifying a target data providing party involved in the computation task, and identifying a computation engine required for the computation task; wherein at least one target data providing party is available.

In an embodiment of the present disclosure, when the task requesting party uses the data locally owned by the data providing party to perform computation such as joint query or joint modeling, the task requesting party sends a task request to the task processing platform and instructs the task processing platform to perform the computation.

After the task processing platform receives the computation request from the task requesting party, the task processing platform parses the computation request and determines the computation task corresponding to the computation request, the data providing party involved in the computation task, and the computation engine required for the computation task. Then computation is performed based on the computation task corresponding to the computation request, the data providing party involved in the computation task, and the computation engine required for the computation task to determine the computation result corresponding to the computation request. Wherein, to facilitate description, the data providing party involved in the computation task is referred to as the target data providing party; and the target data providing party is one or more, which is not limited in the embodiments of the present disclosure.

The computation engine required for the computation task includes a ciphertext computation engine provided in the task processing platform, and/or, a plaintext computation engine provided locally in the target data providing party. The computation task is sent to the corresponding computation engine for computation. Reference is made to the following step 206 to step 210.

Step 206, sending the computation task to the ciphertext computation engine for computation when the computation engine required for a computation task is a ciphertext computation engine.

When the computation engine required for the computation task are determined to be a ciphertext computation engine, it means that there is no computation task which can be performed based on plaintext computation in the computation task corresponding to the computation request. And, the computation task is sent to the ciphertext computation engine in the task processing platform for ciphertext computation.

Step 208: sending the computation task to a plaintext computation engine provided in the target data providing party for computation when the computation engine required for the computation task is a plaintext computation engine provided in the target data providing party.

When the computation engine required for the computation task are determined to be a plaintext computation engine provided in the target data providing party, it means that the computation task corresponding to the computation request is a computation task which can be performed based on plaintext computation. And, the computation task is sent to the plaintext computation engine provided in the target data providing party for plaintext computation.

Step 210: sending the computation task to the plaintext computation engine and the ciphertext computation engine for computation and data interaction when the computation engines required for the computation task are a plaintext computation engine provided in the target data providing party and a ciphertext computation engine.

When the computation engines required for the computation task are determined to be the plaintext computation engine provided in the target data providing party and the ciphertext computation engine, it means that the computation tasks corresponding to the computation request contains a computation task that can be performed based on plaintext computation and a computation task that needs to be performed based on ciphertext computation. And, the computation task that can be performed based on plaintext computation is sent to the plaintext computation engine provided in the target data providing party for plaintext computation, and the computation task that can be performed based on ciphertext computation is sent to the ciphertext computation engine in the task processing platform for ciphertext computation; moreover, in the process of computation by the plaintext computation engine and the ciphertext computation engine, the data interaction between the plaintext computation engine and the ciphertext computation engine is controlled to realize hybrid computation of plaintext and ciphertext.

Step 212, determining the computation result corresponding to the computation request according to the computation result corresponding to the computation request required for the computation task, and sending the computation result corresponding to the computation request to the result demanding party.

In an embodiment of the present disclosure, when the computation engine required for the computation task is a ciphertext computation engine, after the computation task is sent to the ciphertext computation engine for computation, the computation result obtained after the ciphertext computation engine executes all the computation tasks in the computation request is determined as the computation result corresponding to the computation request. When the computation engine required for the computation task is a plaintext computation engine provided in the target data providing party, after the computation task is sent to the plaintext computation engine provided in the target data providing party for computation, the computation result obtained after the plaintext computation engine executes all the computation tasks in the computation request is determined as the computation result corresponding to the computation request. When the computation engine required for the computation task is a plaintext computation engine provided in the target data providing party and a ciphertext computation engine, after the computation task is sent to the plaintext computation engine and the ciphertext computation engine correspondingly for computation and data interaction, the computation result obtained after the plaintext computation engine and the ciphertext computation engine jointly execute all the computation tasks in the computation request is determined as the computation result corresponding to the computation request. Then the computation result corresponding to the computation request is sent to the result demanding party. Wherein, when the computation result is ciphertext, the computation result is decrypted and sent to the result demanding party, so that the result demanding party can have an intuitive computation result.

In the embodiments of the present disclosure, after the task processing platform receives a computation request sent by a task requesting party, the task processing platform parses the computation task corresponding to the computation request, identity the target data providing party involved in the computation task, and identity the computation engine required by the computation task; when the computation engine required for the computation task is a ciphertext computation engine, sends the computation task to the ciphertext computation engine for computation; when the computation engine required for the computation task is a plaintext computation engine provided in the target data providing party, sends the computation task to the plaintext computation engine provided in the target data providing party for computation; when the computation engines required for the computation task are a plaintext computation engine provided in the target data providing party and a ciphertext computation engine, sends the computation task to the plaintext computation engine and the ciphertext computation engine for computation and data interaction; determines the computation result corresponding to the computation request according to the computation result corresponding to the computation engine required for the computation task, and sends the computation result corresponding to the computation request to the result demanding party. In the embodiments of the present disclosure, through determining whether the computation task can be performed by using the plaintext computation engine before performing the ciphertext computation; and sending corresponding computation task to the plaintext engine for computation when the computation task is determined to be computed using the plaintext computation engine; compared with the technical solution in which only the ciphertext computation engine is used to compute all the computation tasks, the embodiments of the present disclosure can improve computational efficiency while ensuring data security.

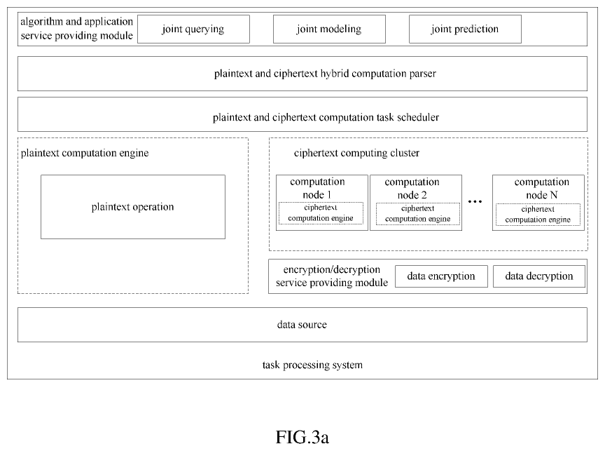

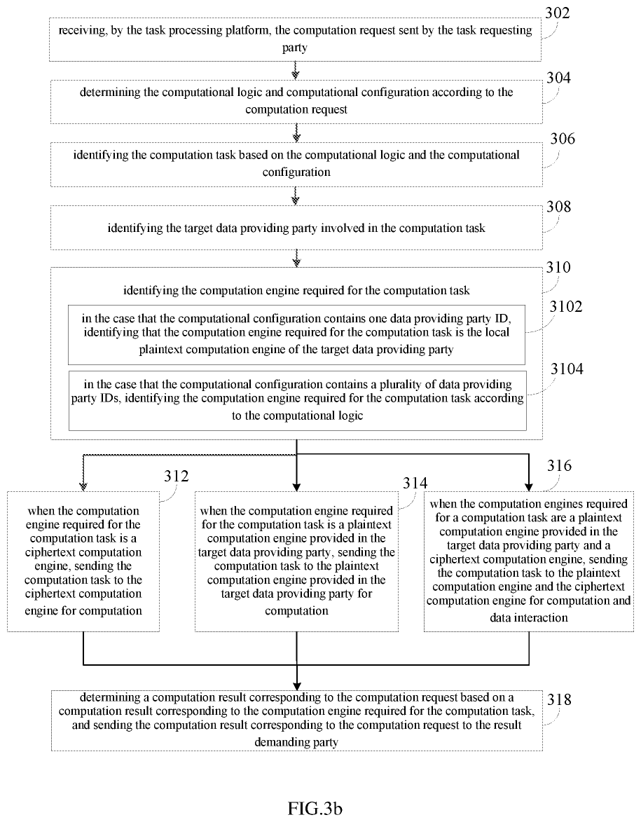

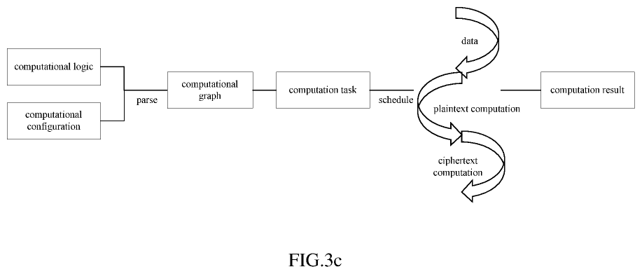

Please refer to FIG. 3a which is a schematic diagram of an application framework of a task processing system in an embodiment of the present disclosure.

The task processing platform in the task processing system includes: an algorithm and application service providing module, a plaintext and ciphertext hybrid computation parser, a plaintext and ciphertext computation task scheduler, and a ciphertext computing cluster. The data providing party in the task processing system includes: a plaintext computation engine, a data source, and an encryption/decryption service providing module.

Wherein the algorithm and application service providing module is configured to provide various algorithms and applications to users (e.g., a task requesting party), and the application include joint querying, joint modeling, and joint prediction; and the algorithm and application service providing module is configured to provide a framework of algorithm or application to developers.

The plaintext and ciphertext hybrid computation parser is configured to parse the computation request. The plaintext and ciphertext computation task scheduler is configured to determine a computation task based on the result parsed by the plaintext and ciphertext hybrid computation parser and to schedule the plaintext computation engine and/or the ciphertext computation engine to perform the computation task.

The ciphertext computing cluster is a cluster for implementing ciphertext computation, and includes N computation nodes, a ciphertext computation engine runs on each computation node, and the ciphertext computation engine provides generic ciphertext computing service. These N computation nodes jointly cooperate to perform complex ciphertext computation through running ciphertext computation engines. In an embodiment, these N computation nodes are provided in each participant in a distributed manner, and each participant manages one computation node. In another embodiment, these N computation nodes are provided independently of each participant, and the management authority of these N computation nodes are dispersed to each computation node. Wherein, N is a positive integer such as 4, which is not limited in the embodiments of the present disclosure. In an embodiment, the ciphertext computing cluster also includes other modules such as a basic computing service providing module, a secure multi-party computation scheduling and management service providing module, etc. Wherein, the secure multi-party computation scheduling and management service providing module is configured to manage and schedule the N computation nodes of ciphertexts; and the basic computing service providing module is configured to provide the basic computation of ciphertexts.

The encryption/decryption service providing module is configured to provide data encryption service and data decryption service.

The plaintext computation engine is used to provide plaintext operation.

In an embodiment, the data source in FIG. 3a is consist of data stored locally by each data providing party.

Wherein, the plaintext and ciphertext hybrid computation parser and the plaintext and ciphertext computation task scheduler in FIG. 3a are included in the computation task management and scheduling module in FIG. 1.

How to parse the computation task corresponding to the computation request and how to identify the computation engine required for the computation task will be described below with reference to FIG. 3a.

In an embodiment of the present disclosure, the computation engine required for the computation task is determined based on the number of data providing parties involved in the computation task.

Please refer to FIG. 3b which is a flow chart of a method for processing data in another embodiment of the present disclosure.

Step 302, receiving, by the task processing platform, the computation request sent by the task requesting party.

In an embodiment of the present disclosure, the task requesting party selects, from the algorithm and application service providing module, the data providing party to which the computing data required for the computation belongs and the required computing data, and selects an algorithm required for the computation or write an algorithm required for the computation, and then performs the submitting operation. The algorithm and application service providing module generates a computation request and send it to the task processing platform through selecting, by the user, the data providing party to which the computing data required for the computation belongs and the required computing data, and selecting the algorithm required for the computation or writing the algorithm required for the computation in the algorithm and application service providing module. The task processing platform receives the computation request sent by the task requesting party, and then performs the corresponding computation and determines the corresponding computation result based on the computation request.

In an embodiment of the present disclosure, a computational logic and a computational configuration are obtained according to the computation request. In an example, the computational logic is expressed by a computational code, and is used for expressing what kind of computation needs to be performed on the data, such as summing the data, or extracting parameters for model training. The computational configuration includes configuration information of the computational logic, for example, data providing party ID, result demanding party ID, computation execution order and computation node ID in this task, etc.

Step 304, determining the computational logic and computational configuration according to the computation request.

Step 306, identifying the computation task based on the computational logic and the computational configuration.

In an embodiment of the present disclosure, if the task requesting party selects, in the algorithm and application service providing module, the data providing party to which the computing data required for the computation belongs and the required computing data, and selects the algorithm required for the computation, the computation request initiated by the task requesting party contains the data providing party identification, the computing data identification and the identification of the algorithm required for the computation. And, the task processing platform configures the corresponding computational logic and computational configuration for the computation request based on the data providing party identification, the computing data identification, and the identification of the algorithm required for the computation contained in the computation request.

In an embodiment of the present disclosure, if the task requesting party selects, in the algorithm and application service providing module, the data providing party to which the computing data required for the computation belongs and the required computing data, and writes the algorithm required for the computation, the computation request initiated by the task requesting party contains the computational logic and the computational configuration. And, the task processing platform extracts the computational logic and the computational configuration from the computation request.

Then the task computation platform identifies the computation task based on the computational logic and computational configuration; and a manner of identifying computation task based on the computational logic and computational configuration is described as the following substeps S3062 to S3064.

Substep S3062, parsing based on the computational logic and the computational configuration to generate a computational graph including a node and an edge connecting the nodes, wherein the node is corresponding to the variable in the computational logic, and the edge is corresponding to the operation in the computational logic.

Substep S3064, generating the computation task based on the computational graph.

In an embodiment of the present disclosure, the computational logic includes a plurality of Jobs, and the dependency relationships contained among these Jobs are determined based on the computational configuration; a topological sorting is performed based on the dependency relationships contained among the Jobs; wherein, the Job with no dependency is sorted at the front. According to this topological sorting, the Job is executed starting from the last Job until all the Jobs are executed, and a computational graph including nodes and edges connecting the nodes is generated. The node corresponds to variable in the computational logic, and the edge corresponds to operation in the computational logic. The computation task is generated based on the computational graph.

Step 308, identifying the target data providing party involved in the computation task.

In an embodiment of the present disclosure, the data providing party ID included in the computational configuration is the data providing party ID involved in the computation task; therefore, the data providing party corresponding to the data providing party ID in the computational configuration is determined as the target data providing party involved in the computation task. In an embodiment, when the computational configuration includes one data providing party ID, one target data providing party is identified; and when the computational configuration includes a plurality of data providing party IDs, a plurality of target data providing parties are identified.

Step 310, identifying the computation engine required for the computation task.

In an embodiment of the present disclosure, the computation engine required for the computation task is determined based on the number of target data providing parties; and reference is made to steps 3102 to 3104.

Step 3102, in the case that the computational configuration contains one data providing party ID, identifying that the computation engine required for the computation task is the local plaintext computation engine of the target data providing party.

That is, when the target data providing party corresponding to the computation request is one, the problem of data leakage will not exist when the computation is performed using the local plaintext computation engine of the target data providing party, and, it is determined that the computation engine required for the computation task is the local plaintext computation engine of the target data providing party, no ciphertext computation is needed, thereby improving the computational efficiency.

Step 3104, in the case that the computational configuration contains a plurality of data providing party IDs, identifying the computation engine required for the computation task according to the computational logic.

In an embodiment of the present disclosure, the computation tasks corresponding to one computation request are more than one; whether the computation engine required for the computation task is a plaintext computation engine or a ciphertext computation engine is determined based on the number of target data providing parties involved in the operation corresponding to each computation task. If the computational configuration contains a plurality of data providing party IDs, according to the computational logic, the computation engine required for each computation task in the computation request is determined based on the number of target data providing parties involved in each computation task in the computation request, respectively. Wherein, if the computational configuration contains a plurality of data providing party IDs, and if determining the operation involved in the computation task is for data of a single target data providing party based on the computational logic, it is identified that the computation engine required for the computation task is the plaintext computation engine, otherwise the computation engine required for the computation task is a ciphertext computation engine.

Then, the computation task is sent to the corresponding required computation engine for computation based on the computation engine required for each computation task corresponding to the computation request according to steps 312 to 316.

Step 312, when the computation engine required for the computation task is a ciphertext computation engine, sending the computation task to the ciphertext computation engine for computation.

In an embodiment, after the ciphertext computation engine receives the computation task, the ciphertext computation engine acquires the computing data from the target data providing party involved in the computation task and performs the ciphertext computation, the computing data is in ciphertext. Wherein, the target data providing party encrypts the local computing data through the encryption/decryption service providing module to obtain the ciphertext computing data; and then sends the ciphertext computing data to the ciphertext computation engine for computation so as to ensure data security.

Step 314, when the computation engine required for the computation task is a plaintext computation engine provided in the target data providing party, sending the computation task to the plaintext computation engine provided in the target data providing party for computation.

In an embodiment, after the plaintext computation engine provided in the target data providing party receives a computation task, the plaintext computation engine acquires the computing data corresponding to the computation task from the target data providing party in which the plaintext computation engine is located and performs the plaintext computation, the computing data is in plaintext.

Step 316, when the computation engines required for a computation task are a plaintext computation engine provided in the target data providing party and a ciphertext computation engine, sending the computation task to the plaintext computation engine and the ciphertext computation engine for computation and data interaction.

In an embodiment of the present disclosure, during the plaintext computation performed by the plaintext computation engine and the ciphertext computation performed by the ciphertext computation engine, the encryption/decryption service providing module in the target data providing party determines the interaction data between the ciphertext computation engine and the plaintext computation engine according to the computation task, and realize the interaction of data between the ciphertext computation engine and the plaintext computation engine by encrypting or decrypting the interaction data. In an embodiment, the first ciphertext interaction data output by the ciphertext computation engine is determined based on the computation task; the first ciphertext interaction data is decrypted to obtain the first plaintext interaction data and sent it to the plaintext computation engine; and/or, the second plaintext interaction data output by the plaintext computation engine is determined based on the computation task; the second plaintext interaction data is encrypted to obtain the second ciphertext interaction data and sent it to the ciphertext computation engine.

Please refer to FIG. 3c which is a schematic diagram of a data processing process in an embodiment of the present disclosure. The task processing platform parses according to the computational logic and the computational configuration to obtain a computational graph, and then determines the computation task according to the computational graph. According to the computation task, the task processing platform schedules the plaintext computation engine for plaintext computation and the ciphertext computation engine for ciphertext computation, and data interaction between the ciphertext computation engine and the plaintext computation engine to obtain computation result.

Step 318: determining a computation result corresponding to the computation request based on a computation result corresponding to the computation engine required for the computation task, and sending the computation result corresponding to the computation request to the result demanding party.

In embodiments of the present disclosure, if the computational configuration contains one data providing party ID, the target data providing party is identified according to the data providing party ID, and it is identified that the computation engine required for the computation task is a local plaintext computation engine of the target data providing party; if the computational configuration contains a plurality of data providing party IDs, a plurality of target data providing parties are identified according to the data providing party IDs, and if it is determined based on the computational logic that the operation involved in the computation task is for data of a single target data providing party, it is identified that the computation engine required for the computation task is a plaintext computation engine, otherwise the computation engine required for the computation task is a ciphertext computation engine. In the embodiments of the present disclosure, whether the computation engine required for each computation task is a plaintext computation engine or a ciphertext computation engine is determined according to the number of data providing party involved in each computation task, the efficiency in determining which kind of computation engine is required for a computation task can be improved, and the computational efficiency can be improved.

In an embodiment of the present disclosure, whether the computation task is a plaintext computation task or a ciphertext computation task is parsed when the computation task corresponding to the computation request is parsed; and the computation engine required for the computation task is determined according to the type of the computation task.

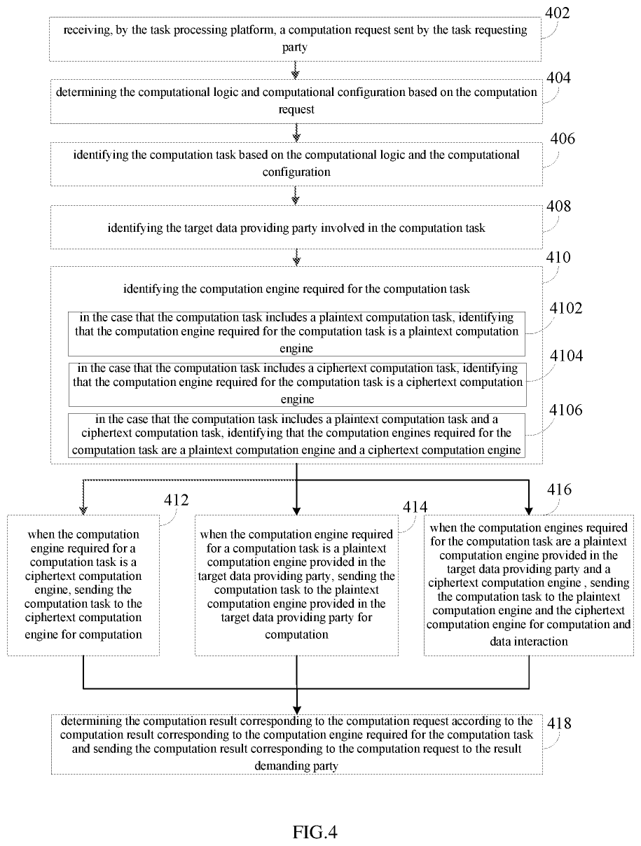

Please refer to FIG. 4 which is a flow chart of a method for processing data in another embodiment of the present disclosure.

Step 402, receiving, by the task processing platform, a computation request sent by the task requesting party.

Step 404, determining the computational logic and computational configuration based on the computation request.

Step 402 to step 404 are similar to the above step 302 to step 304, and will not be described herein.

Step 406, identifying the computation task based on the computational logic and the computational configuration.

In an embodiment of the present disclosure, a manner of identifying the computation task based on the computational logic and the computational configuration is described as the following substeps S4062 to the S4064.

Substep S4062, parsing based on the computational logic and the computational configuration to generate a computational graph including a node and an edge connecting the nodes, wherein the node corresponds to the variable in the computational logic, and the edge corresponds to the operation in the computational logic.

Substep S4064, generating the computation task based on the computational graph.

In embodiments of the present disclosure, the input parameter for each group of computation in the computational logic has a preset identification, the preset identification includes a plaintext identification or a ciphertext identification, and after the substep S4062, the method further includes: adding the plaintext identification to corresponding node in the computational graph based on the plaintext identification of the input parameter for each group of computation, and adding the ciphertext identification to corresponding node in the computational graph based on the ciphertext identification of the input parameters for each group of computation.

The substep S4064 includes: determining the computation task based on the preset identification of the node and the edge associated with the node in the computational graph, wherein the computation task includes: a plaintext computation task and/or a ciphertext computation task.

In an embodiment, the plaintext computation task is generated based on the node with plaintext identification and the edge associated with the node with plaintext identification, and the ciphertext computation task is generated based on the node with ciphertext identification and the edge associated with the node with ciphertext identification.

Step 408, identifying the target data providing party involved in the computation task.

Step 408 is similar to the above step 308, and will not be described herein.

Step 410, identifying the computation engine required for the computation task.

In an embodiment of the present disclosure, the computation engine required for the computation task is determined according to the type of the computation task, and please refer to step 4102 to step S4106.

Step 4102, in the case that the computation task includes a plaintext computation task, identifying that the computation engine required for the computation task is a plaintext computation engine.

Step 4104, in the case that the computation task includes a ciphertext computation task, identifying that the computation engine required for the computation task is a ciphertext computation engine.

Step 4106, in the case that the computation task includes a plaintext computation task and a ciphertext computation task, identifying that the computation engines required for the computation task are a plaintext computation engine and a ciphertext computation engine.

Then, the computation task is sent to the corresponding required computation engine for computation based on the computation engine required for each computation task corresponding to the computation request according to steps 412 to 416.

Step 412, when the computation engine required for a computation task is a ciphertext computation engine, sending the computation task to the ciphertext computation engine for computation.

Step 414, when the computation engine required for a computation task is a plaintext computation engine provided in the target data providing party, sending the computation task to the plaintext computation engine provided in the target data providing party for computation.

Step 416: when the computation engines required for the computation task are a plaintext computation engine provided in the target data providing party and a ciphertext computation engine, sending the computation task to the plaintext computation engine and the ciphertext computation engine for computation and data interaction.

Step 412 to step 416 are similar to the above step 312 to step 316, and will not be described herein.

Step 418, determining the computation result corresponding to the computation request according to the computation result corresponding to the computation engine required for the computation task and sending the computation result corresponding to the computation request to the result demanding party.

In an embodiment of the present disclosure, after the computational graph is generated, the plaintext identification is added to corresponding node in the computational graph based on the plaintext identification of the input parameter for each group of computation, and the ciphertext identifications is added to corresponding node in the computational graph based on the ciphertext identification of the input parameter for each group of computation. And then, the computation task is determined based on the preset identification of the node and the edge associated with the node in the computational graph, wherein the computation task includes a plaintext computation task and/or a ciphertext computation task. Further, if the computation task includes a plaintext computation task, it is identified that the computation engine required for the computation task is a plaintext computation engine; if the computation task includes a ciphertext computation task, it is identified that the computation engine required for the computation task is a ciphertext computation engine; if the computation task includes a plaintext computation task and a ciphertext computation task, it is identified that the computation engines required for the computation task are a plaintext computation engine and a ciphertext computation engine, so that the computation engine required for the computation task can be identified according to the type of the computation task. In the case that more data providing parties are involved in the computation task, or more computation tasks exist, compared with the above identification of the computation engine required for the computation task according to the number of data providing parties involved in the computation task, in the embodiment of the present disclosure, when the computational graph is generated to determine the input parameter, the node in the computational graph is marked based on the identification of the input parameter, so that it is not necessary to query the data providing party involved in the computation task each time, the efficiency in identifying the computation engine can be improved.

In an embodiment of the present disclosure, after the computing data required by the ciphertext computation engine to perform the corresponding computation task is encoded in slices, the target data providing party sends the computing data to the ciphertext computation engine based on a secret sharing protocol. A manner of ciphertext computation by the ciphertext computation engine is as follows: the ciphertext computation engine computes the computing data uploaded by the target data providing party based on the secret sharing protocol on the basis of the ciphertext. If the ciphertext computation engine and the plaintext computation engine need to exchange data, the target data providing party encodes in slices the plaintext data output by the local plaintext computation engine based on the secret sharing protocol to obtain the ciphertext data, and sends the ciphertext data to the ciphertext computation engine, and the ciphertext computation engine performs ciphertext computation based on the ciphertext data.

In an embodiment of the present disclosure, a public key and a private key are generated cooperatively by each target data providing party based on a homomorphic encryption protocol, with the ciphertext computing platform holding the public key and each target data providing party holding a portion of the private key. Each target data providing party encrypts the computing data required by the ciphertext computation engine to perform the corresponding computation task based on the held public key, and then uploads the encrypted computation to the ciphertext computation engine. A manner of ciphertext computation by the ciphertext computation engine as follows: the computing data uploaded by the target data providing party is computed based on a homomorphic encryption protocol on the basis of the ciphertext. If the ciphertext computation engine and the plaintext computation engine need to exchange data, the target data providing party encrypts the plaintext data output by the local plaintext computation engine based on the held public key to obtain the ciphertext data, and sends the ciphertext data to the ciphertext computation engine, and the ciphertext computation engine performs the ciphertext computation based on the ciphertext data.

The process in which the task processing platform sends the computation task to the ciphertext computation engine for computation is described below.

Please refer to FIG. 5 which is a flow chart of a ciphertext computation method based on the secure multi-party computation protocol in an embodiment of the present disclosure, and the following steps are included.

Step 502, determining, by the task processing platform, the computation task and the corresponding computing data.

Step 504, generating multi-party computing instruction corresponding to the computation task based on secure multi-party computation protocol, and sending the multi-party computing instruction and computing data to the ciphertext computation engine in the task processing platform.

In an embodiment of the present disclosure, the task processing platform determines the computation task to be sent to the ciphertext computation engine and the computing data required for the computation task, and then invoke the ciphertext computation engine in the task processing platform to process the computing data corresponding to the computation task.

In an embodiment, the task processing platform converts the computation task into the multi-party computing instruction in advance according to the pre-constructed secure multi-party computation protocol corresponding to each computation task; and then sends the multi-party computing instruction and the corresponding computing data to the ciphertext computation engine.

Wherein, the secure multi-party computation protocol refers to a process in which each computation node in the ciphertext computation engine is instructed and scheduled to perform multi-party computation corresponding to the computation task, which includes but is not limited to: a multi-party computing execution process describing a computation task for mathematical computation such as addition, subtraction, multiplication or division, a multi-party computing execution process describing a computation task for logical computation such as logical sum, or, non, xor, comparison, etc., a multi-party computing execution process describing secret transmission, and so on. Wherein, the multi-party computing instruction includes: instruction used for instructing each computation node in the ciphertext computation engine to perform local computation when performing the computation task through the multi-party computation, instruction used for performing data interaction between computation nodes, instruction used for obtaining computing data, and instruction used for generating random numbers, and so on. The multi-party computation instruction further contains instruction for computing role used for instructing computation nodes to perform the local computation and data interaction. The multi-party computing instruction is described by a computer programming language, or by a machine language.

And then, the ciphertext computation engine processes the corresponding computed data based on the multi-party computing instruction.

Step 506, acquiring, by the ciphertext computation engine, multi-party computing instruction and computing data.

In an embodiment, the ciphertext computation engine includes multiple computation nodes, and processes the computing data corresponding to the computation task through the cooperative computation of a plurality of computation nodes; for example, the number of computation nodes contained in the ciphertext computation engine is set according to requirements, such as 4, which is not limited in the embodiment of the present disclosure.

In some examples, each computation node of the ciphertext computation engine acquires the complete multi-party computing instructions of the computation task, i.e., acquires the computing instruction to be executed by each computation node. In order to enable each computation node to execute cooperatively, the step includes: each computation node acquires the multi-party computing instruction and computing role, and each computation node executes the multi-party computing instruction according to the computing role acquired respectively. Wherein, the computing role is used for marking each computation node that performs local computation in the multi-party computing instruction, and marking the data sending party and the data receiving party that perform interactions between computation nodes in the multi-party computing instruction, and so on.

In some examples, each computation node of the ciphertext computation engine acquires the computing instruction being executed locally in the multi-party computing instructions, respectively. Wherein, the locally executed computing instruction contains an instruction used for performing local computation, an instruction used for issuing locally stored data for data interaction, an instruction used for storing the received data locally for data interaction, an instruction used for acquiring processed input data, and an instruction used for generating random number, and so on. For example, the multi-party computing instructions contain the instruction P1 used for generating random number r₁₂ by the computation node S1, the instruction Pa used for generating random number r_{ab} by the computation node Sa, and then the computation node S1 acquires the instruction P1 and the computation node Sa acquires the instruction Pa.

To perform the computation task, each computation node in the ciphertext computation engine also acquires the corresponding computing data. The computing data includes data uploaded by the target data providing party; for example, the data uploaded by the target data providing party is obtained through randomly dispersing the trained data by the target data providing party based on the random dispersion processing manner required when the ciphertext computation engine performs the multi-party computation. In an embodiment of the present disclosure, the random dispersion processing manner includes: generating at least one piece of private data randomly, and dispersing the input data according to the generated private data. In one example, the random dispersion processing manner includes: randomly generating two pieces of private data x₁ and x₁′, dispersing the input data X into {x₁, x₁′, x₂, x₂′, xₐ, xₐ′, x_{b}, x_{b}′} based on the private data x₁ and x₁′; wherein x₂=X−x₁=xₐ, x₁=x_{b}, x₂′=X−x₁′=x_{b}′, x₁′=xₐ′. The computing data also includes data in the task processing platform, and the data in the task processing platform is ciphertext or plaintext, which is not limited in embodiments of the present disclosure. In an example, the ciphertext data in the task processing platform is obtained through randomly dispersing the trained data by the ciphertext computation engine based on the random dispersion processing manner required by the ciphertext computation engine to perform multi-party computation. In an embodiment, the manner of random dispersion processing by the target data providing party is consistent with the manner of random dispersion processing by the task processing platform.

In an embodiment, in the case that the computing data is ciphertext, the computing data acquired by each node is at least one ciphertext fragment of the computing data, and all the ciphertext fragments of the computing data form the plaintext of the computing data. For example, in the above example, the ciphertext of data X is {x₁, x₁′, x₂, x₂′, xₐ, xₐ′, x_{b}, x_{b}′}; if 4 computation nodes are available, the ciphertext fragment of the computing data acquired by each computation node is {x₁, x₁′}, {x₂, x₂′}, {xₐ, xₐ′} and {x_{b}, x_{b}′}. In the case that the computing data is plaintext, the computing data acquired by each node is the computing data itself. In the case that the computing data includes plaintext and ciphertext, the computing data acquired by the computation node is at least one ciphertext fragment of the ciphertext and plaintext. For example, the computing data includes A1 and A2, wherein A1 is the ciphertext that is randomly dispersed as {a₁,a₂}, and A2 is the plaintext portion. The computing data acquired by the computation node 1 is a₁ and A2, and the computing data acquired by the computation node 2 is a₂ and A2.

Step 508: according to the multi-party computing instructions, at least some of the computation nodes in the ciphertext computation engine perform local computation on the computing data acquired by each computation node, and/or interact the intermediate data generated by the local computation, to obtain the computation result held by each computation node, respectively.

Wherein, according to the computation task, the multi-party computing instructions instruct some of the computation nodes to perform local computations only and obtain computation results. In some examples, the multi-party computing instruction contains an instruction generated based on a computation with homomorphism in the computation task; according to the multi-party computing instructions, the computation node in the ciphertext computation engine performs a local computation and obtains a corresponding computation result. Wherein the homomorphism indicates that there is a closed operation with associative laws, for example, an addition computation, etc. In performing an addition computation by using the ciphertext computation engine, the multi-party computing instruction instructs two computation nodes to perform an addition computation of computing data A1 and A2 and obtains the corresponding computation result held by each node. The task processing platform obtains the processing results of A1+A2 through acquiring the computation results of the two computation nodes.

In some examples, the multi-party computing instructions contain an instruction used for instructing each computation node to perform local computation on the acquired corresponding computing data group, and an instruction used for interacting the intermediate data resulting from the local computation. In some examples, the multi-party computing instructions correspond to each computation involved in the computation task. In some examples, the multi-party computing instruction contains an instruction set based on an association relationship among a plurality of computations in the computation task. Wherein the association relationship among the plurality of computations includes, but is not limited to, computational priority relationship, computing homomorphism, computing synchronization, randomly dispersion processing manner for computing data required for the computation, and the like. According to the association relationship, the task processing platform or the ciphertext computation engine optimizes local computation and data interaction for each computation node, and then each computation node executes the instruction for local computation and instruction for data interaction according to the optimized multi-party computing instruction. For example, if the computation task contains (X+Y)×Z, the multi-party computing instructions contain: an instruction used for instructing two computation nodes to perform local computation to obtain the corresponding (X+Y) multi-party computation, an instruction used for instructing the two computation nodes to take each computation result corresponding to the (X+Y) multi-party computation held by each node as intermediate data and perform random dispersion processing, and an instruction used for instructing a plurality of computation nodes to perform the corresponding (X+Y)×Z multi-party computation, and so on.

Step 510, determining, by the task processing platform, the processing result corresponding to the computation task based on the computation result held by each computation node.

After the ciphertext computation engine obtains the computation results corresponding to the computation task, the task processing platform selects computation results held by some computation nodes from the plurality of computation nodes to generate a processing result; wherein the processing result is a processing result obtained when the computation task processes the computing data.

Further, the task processing platform sends the computation task to the ciphertext computation engine for computation with reference to step 502 to step 510.

It should be noted that the method embodiments are presented as a series of combinations of steps for simplicity of description, but those skilled in the art should be known that the embodiments of the present disclosure are not limited by the sequence of steps described, and some steps may be performed in other sequences or simultaneously according to the embodiments of the present disclosure. In addition, those skilled in the art should also be known that the embodiments described in the specification are preferred embodiments and that the steps described are not the necessary steps required by the embodiments of the present disclosure.

The present application discloses an apparatus configured to process data, the apparatus is used in a task processing system, wherein the task processing system includes a task processing platform, a task requesting party, a data providing party, and a result demanding party; the task processing platform is provided with a ciphertext computation engine, the data providing party being provided with a plaintext computation engine, and the apparatus is deployed on the task processing platform.

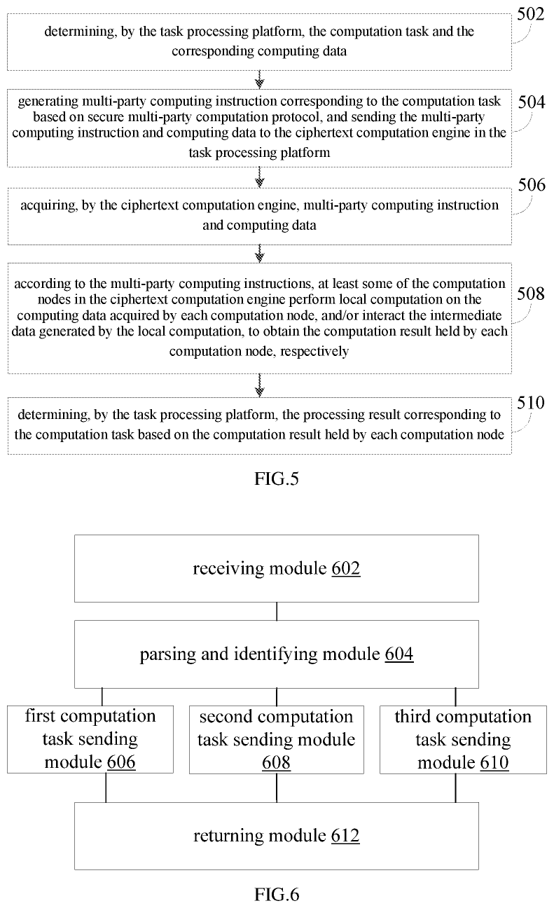

Please refer to FIG. 6, which is a structural schematic diagram of a data processing apparatus in an embodiment of the present disclosure, the apparatus includes the following modules:

receiving module 602, configured to receive a computation request sent by the task requesting party;

parsing and identifying module 604, configured to parse a computation task corresponding to the computation request, identify a target data providing party involved in the computation task, and identify a computation engine required for the computation task; wherein at least one target data providing party is available;

a first computation task sending module 606, configured to send the computation task to the ciphertext computation engine for computation when the computation engine required for the computation task is the ciphertext computation engine;

a second computation task sending module 608, configured to send the computation task to a plaintext computation engine provided in the target data providing party for computation when the computation engine required for the computation task is the plaintext computation engine provided in the target data providing party;

a third computation task sending module 610, configured to send the computation task to the plaintext computation engine and the ciphertext computation engine for computation and data interaction when computation engines required for the computation task are the plaintext computation engine provided in the target data providing party and the ciphertext computation engine;

a returning module 612, configured to determine a computation result corresponding to the computation request based on a computation result corresponding to the computation engine required for the computation task, and send the computation result corresponding to the computation request to the result demanding party.

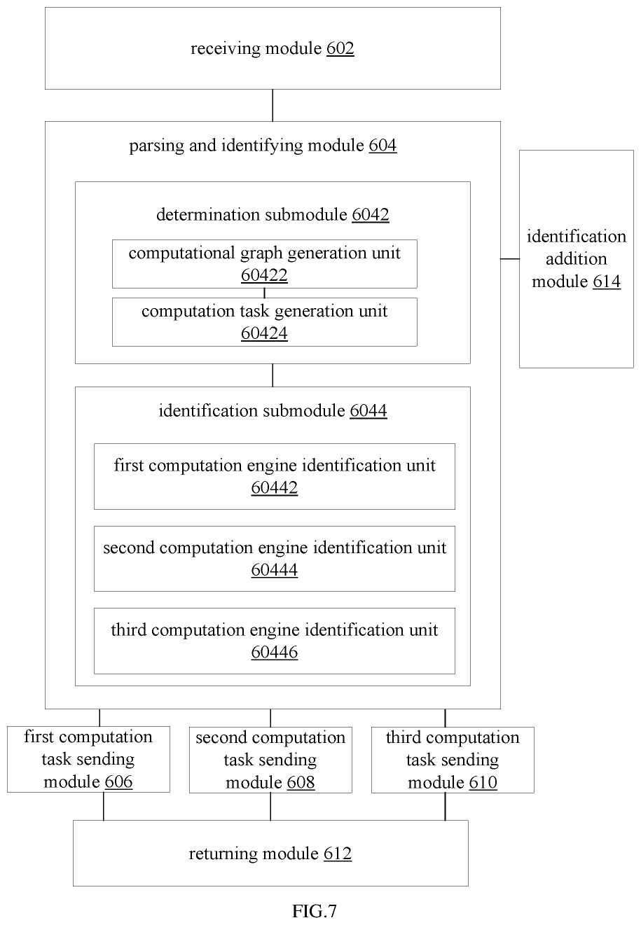

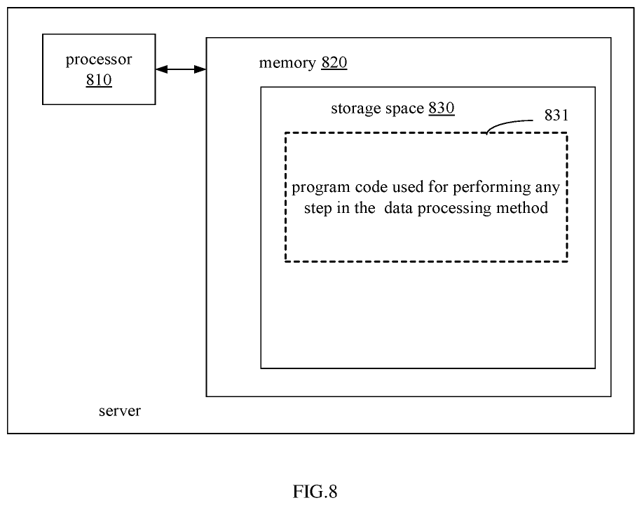

Please refer to FIG. 7, which is a structural schematic diagram of a data processing apparatus in another embodiment of the present disclosure.

In an embodiment, the parsing and identifying module 604 includes:

a determination submodule 6042, configured to determine a computational logic and a computational configuration based on the computation request;

an identification submodule 6044, configured to identify, based on the computational logic and computational configuration, the computation task, the target data providing party involved in the computation task, and the computation engine required for the computation task.

In an embodiment, the determination submodule 6042 includes: a computational graph generation unit 60422, configured to parse based on the computational logic and the computational configuration to generate a computational graph, wherein, the computational graph comprises a node and an edge connecting the nodes, the node is corresponding to a variable in the computational logic, and the edge is corresponding to an operation in the computational logic; and a computation task generation unit 60424, configured to generate the computation task based on the computational graph.

In an embodiment, the computational configuration contains a data providing party ID involved in the computation task, and the identification submodule 6044 includes: a first computation engine identification unit 60442, configured to, in the case that the computational configuration contains one data providing party ID, identify the target data providing party according to the data providing party ID, and identify that the computation engine required for the computation task is a local plaintext computation engine of the target data providing party; and a second computation engine identification unit 60444, configured to, in the case that the computational configuration contains a plurality of data providing party IDs, identify a plurality of target data providing parties according to the data providing party IDs, and identify the computation engine required for the computation task according to the computational logic.

In an embodiment, the second computation engine identification unit 60444 is configured to identify that the computation engine required for the computation task is the plaintext computation engine if determining, based on the computational logic, that an operation involved in the computation task is for data of a single target data providing party; and identify that the computation engine required for the computation task is the ciphertext computation engine if not.

In an embodiment, an input parameter for each group of computation in the computational logic has a preset identification, and the preset identification comprises a plaintext identification or a ciphertext identification; the apparatus further includes:

an identification addition module 614, configured to add the plaintext identification to corresponding node in the computational graph based on the plaintext identification of the input parameter for each group of computation, and add the ciphertext identification to corresponding node in the computational graph based on the ciphertext identification of the input parameter for each group of computation; the computational graph generation unit 60422 is configured to determine the computation task based on the preset identification of the node and an edge associated with the node in the computational graph, wherein the computation task comprises: a plaintext computation task and/or a ciphertext computation task; the identification submodule 6044 includes a third computation engine identification unit 60446, configured to identify that the computation engine required for the computation task is the plaintext computation engine in the case that the computation task comprises the plaintext computation task; identify that the computation engine required for the computation task is the ciphertext computation engine in the case that the computation task comprises the ciphertext computation task; and identify that the computation engines required for the computation task are the plaintext computation engine and the ciphertext computation engine in the case that the computation task comprises the plaintext computation task and the ciphertext computation task.

In the embodiments of the present disclosure, after the task processing platform receives a computation request sent by a task requesting party, the task processing platform parses the computation task corresponding to the computation request, identity the target data providing party involved in the computation task, and identity the computation engine required by the computation task; when the computation engine required for the computation task is a ciphertext computation engine, sends the computation task to the ciphertext computation engine for computation; when the computation engine required for the computation task is a plaintext computation engine provided in the target data providing party, sends the computation task to the plaintext computation engine provided in the target data providing party for computation; when the computation engines required for the computation task are a plaintext computation engine provided in the target data providing party and a ciphertext computation engine, sends the computation task to the plaintext computation engine and the ciphertext computation engine for computation and data interaction; determines the computation result corresponding to the computation request according to the computation result corresponding to the computation engine required for the computation task, and sends the computation result corresponding to the computation request to the result demanding party. In the embodiments of the present disclosure, through determining whether the computation task can be performed by using the plaintext computation engine before performing the ciphertext computation; and sending corresponding computation task to the plaintext engine for computation when the computation task is determined to be computed using the plaintext computation engine; compared with the technical solution in which only the ciphertext computation engine is used to compute all the computation tasks, the embodiments of the present disclosure can improve computational efficiency while ensuring data security.

For the apparatus embodiment, since it is substantially similar to the method embodiment, the description is relatively simple, and for the related part, please refer to the description for the method embodiment.

Embodiment of the present disclosure also discloses a readable medium, when the instruction in the medium is executed by a processor in an electronic equipment, the electronic equipment performs the data processing method as described in one or more embodiments of the present disclosure.

Embodiment of the present disclosure also discloses an electronic equipment, the electronic equipment includes one or more processors and one or more readable media, an instruction is stored in the medium and is configured as by one or more of processors execute for performing the data processing method in the above embodiments of the present disclosure.

Electronic equipment such as a server is disclosed in an embodiment of the present disclosure, and FIG. 8 shows the server of the present disclosure, such as a management server, a storage server, an application server, a cloud control service, a server cluster, and the like. In general, the server includes a processor 810 and a computer program product or a computer readable medium in the form of a memory 820. The memory 820 is for example an electronic memory such as a flash memory, an EEPROM (electrically erasable programmable read-only memory), an EPROM, a hard disk, or an ROM. The memory 820 has a storage space 830 for program code 831 used for performing any step in the above method. For example, the storage space 830 for the program code includes each program code 831 for implementing the various steps in the above method respectively. These program codes are read from or written into one or more computer program products. These computer program products include a program code carry such as hard disk, compact disks (CD), memory card, or floppy disk. Such computer program product is a portable or fixed storage unit. The storage unit is provided with a storage segment, a storage space and the like which are similarly to the arrangement of the memory 820 in the server of FIG. 8. The program code is for example compressed in an appropriate form. Generally, the storage unit includes the computer readable code, i.e., code that is read by, for example, a processor such as 810, and when the code is run by the server, the server performs the various steps in the method described above.

The various embodiments in the present disclosure are described in a progressive manner, with each embodiment focusing on the differences from the other embodiments, and the same or similar parts among the various embodiments can be referred to with each other.

Those skilled in the art should be note that the embodiments of the present disclosure can be embodied as a method, a device, or a computer program product. Therefore, the embodiments of the present disclosure can be embodied in the form of an all-hardware embodiment, an all-software embodiment or an embodiment of software and hardware in combination. Furthermore, the embodiments of the present disclosure can be embodied in the form of a computer program product embodied in one or more computer useable storage media (including but not limited to a disk memory, CD-ROM, an optical memory, etc.) in which computer useable program codes are contained.

The embodiments of the present disclosure have been described in a flow chart and/or a block diagram of the method, the terminal device (system) and the computer program product according to the embodiments of the present disclosure. It should be noted that each flow and/or block in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of other programmable data processing terminal device to form a machine, such that the instructions executed on the computer or the processor of the other programmable data processing terminal device correspond to means for performing the functions specified in the one or more flows of the flow chart and/or the one or more blocks of the block diagram.

These computer program instructions can also be stored into a computer readable memory capable of directing the computer or the other programmable data processing terminal devices to operate in a specific manner, so that the instructions stored in the computer readable memory correspond to a manufactured product including instruction means, and such instruction means perform the functions specified in the flow(s) of the flow chart and/or the block(s) of the block diagram.

These computer program instructions can also be loaded onto the computer or the other programmable data processing terminal devices, such that a series of operational steps are performed on the computer or the other programmable terminal devices to result in computer-implemented processing, the instructions executed on the computer or the other programmable terminal devices provide steps for implementing the functions specified in the flow(s) of the flow chart and/or the block(s) of the block diagram.

Although the embodiments of the present disclosure have been described, but those skilled in the art can make additional variations and modifications to these embodiments once they learn about the concept of basic creativity. Therefore, the appended claims are interpreted to encompass the described embodiments and all the variations and modifications falling within the scope of the embodiments of the present disclosure.

It should also be noted that, in this text, terms such as first and second are used only to distinguish one entity or operation from another entity or operation, without indicating any actual relationship or order between those entities or operations. Furthermore, the terms “include”, “comprise” and any other variation thereof are intended to cover non-exclusive inclusion, such that the process, method, product, or terminal device including a set of elements includes not only those elements, but also other elements not expressly listed, or includes elements that are inherent to such process, method, product, or terminal device. Without further limitation, the elements defined by the statement “including a” do not exclude the existence of additional corresponding elements in the process, method, product, or terminal device that includes the elements.

A brief introduction is given above on a method for processing data, a task processing system, and an electronic equipment configured to process data provided in the present disclosure, and specific examples are shown in the text to elaborate the principles and embodiments of the present disclosure. The description of the above examples is merely used to help understanding the method of the present disclosure and its core ideas; for those skilled in the art, the specific embodiments and the scope of application can be changed based on the idea of the present disclosure, thus, the content of the present specification should not be understood as a limitation to the present disclosure.

### Other Embodiments

A number of embodiments have been described. Nevertheless, it will be understood that various modifications may be made without departing from the spirit and scope of the disclosure.

Accordingly, other embodiments are within the scope of the following claims.

What is claimed is:

1. A method for processing data, being used in a task processing system, wherein the task processing system comprises a task processing platform, a task requesting party, a data providing party, and a result demanding party; the task processing platform being provided with a ciphertext computation engine, the data providing party being provided with a plaintext computation engine, and the method comprising the following steps:
receiving, by the task processing platform, a computation request sent by the task requesting party;
parsing a computation task corresponding to the computation request, identifying a target data providing party involved in the computation task, and identifying a computation engine required for the computation task; wherein at least one target data providing party is available;
sending the computation task to the ciphertext computation engine for computation when the computation engine required for the computation task is the ciphertext computation engine;
sending the computation task to a plaintext computation engine provided in the target data providing party for computation when the computation engine required for the computation task is the plaintext computation engine provided in the target data providing party;
sending the computation task to the plaintext computation engine and the ciphertext computation engine for computation and data interaction when computation engines required for the computation task are the plaintext computation engine provided in the target data providing party and the ciphertext computation engine; and
determining a computation result corresponding to the computation request based on a computation result corresponding to the computation engine required for the computation task, and sending the computation result corresponding to the computation request to the result demanding party.

2. The method of claim 1, wherein, the step of parsing a computation task corresponding to the computation request, identifying a target data providing party involved in the computation task, and identifying a computation engine required for the computation task comprises the following steps:
determining a computational logic and a computational configuration based on the computation request; and
identifying, based on the computational logic and computational configuration, the computation task, the target data providing party involved in the computation task, and the computation engine required for the computation task.

3. The method of claim 2, wherein, the step of identifying the computation task based on the computational logic and computational configuration comprises:
parsing based on the computational logic and the computational configuration to generate a computational graph, wherein, the computational graph comprises a node and an edge connecting the nodes, the node is corresponding to a variable in the computational logic, and the edge is corresponding to an operation in the computational logic; and
generating the computation task based on the computational graph.

4. The method of claim 2, wherein, the computational configuration contains a data providing party ID involved in the computation task, and the step of identifying a target data providing party involved in the computation task and identifying a computation engine required for the computation task comprises:
in the case that the computational configuration contains one data providing party ID, identifying the target data providing party according to the data providing party ID, and identifying that the computation engine required for the computation task is a local plaintext computation engine of the target data providing party; and
in the case that the computational configuration contains a plurality of data providing party IDs, identifying a plurality of target data providing parties according to the data providing party IDs, and identifying the computation engine required for the computation task according to the computational logic.

5. The method of claim 4, wherein, the step of identifying the computation engine required for the computation task according to the computational logic comprises:
if determining, based on the computational logic, that an operation involved in the computation task is for data of a single target data providing party, identifying that the computation engine required for the computation task is the plaintext computation engine; if not, identifying that the computation engine required for the computation task is the ciphertext computation engine.

6. The method of claim 3, wherein, an input parameter for each group of computation in the computational logic has a preset identification, and the preset identification comprises a plaintext identification or a ciphertext identification;
the method further comprises:
adding the plaintext identification to corresponding node in the computational graph based on the plaintext identification of the input parameter for each group of computation, and adding the ciphertext identification to corresponding node in the computational graph based on the ciphertext identification of the input parameter for each group of computation;
the step of generating the computation task based on the computational graph comprises:
determining the computation task based on the preset identification of the node and an edge associated with the node in the computational graph, wherein the computation task comprises: a plaintext computation task and/or a ciphertext computation task;
the step of identifying the computation engine required for the computation task comprises:
in the case that the computation task comprises the plaintext computation task, identifying that the computation engine required for the computation task is the plaintext computation engine;
in the case that the computation task comprises the ciphertext computation task, identifying that the computation engine required for the computation task is the ciphertext computation engine; and
in the case that the computation task comprises the plaintext computation task and the ciphertext computation task, identifying that the computation engines required for the computation task are the plaintext computation engine and the ciphertext computation engine.

7. A task processing system, comprising: a task processing platform, a task requesting party, a data providing party, and a result demanding party; the task processing platform being provided with a ciphertext computation engine, the data providing party being provided with a plaintext computation engine, wherein, the task processing platform is configured to:
receive, by the task processing platform, a computation request sent by the task requesting party;
parse a computation task corresponding to the computation request, identify a target data providing party involved in the computation task, and identify a computation engine required for the computation task; wherein at least one target data providing party is available;
send the computation task to the ciphertext computation engine for computation when the computation engine required for the computation task is the ciphertext computation engine;
send the computation task to a plaintext computation engine provided in the target data providing party for computation when the computation engine required for the computation task is the plaintext computation engine provided in the target data providing party;
send the computation task to the plaintext computation engine and the ciphertext computation engine for computation and data interaction when computation engines required for the computation task are the plaintext computation engine provided in the target data providing party and the ciphertext computation engine; and
determine a computation result corresponding to the computation request based on a computation result corresponding to the computation engine required for the computation task, and send the computation result corresponding to the computation request to the result demanding party.

8. The system of claim 7, wherein, the task processing platform is provided with a computation task management and scheduling module, the computation task management and scheduling module is configured to schedule the plaintext computation engine and the ciphertext computation engine for computation.

9. An electronic equipment, comprising:
one or more processors;
one or more readable media, an instruction be stored in the readable media and be configured as by one or more of processors execute for performing a method for processing data, wherein, the method for processing data is used in a task processing system, the task processing system comprises a task processing platform, a task requesting party, a data providing party, and a result demanding party; the task processing platform being provided with a ciphertext computation engine, the data providing party being provided with a plaintext computation engine, and the method comprising the following steps:
receiving, by the task processing platform, a computation request sent by the task requesting party;
parsing a computation task corresponding to the computation request, identifying a target data providing party involved in the computation task, and identifying a computation engine required for the computation task; wherein at least one target data providing party is available;
sending the computation task to the ciphertext computation engine for computation when the computation engine required for the computation task is the ciphertext computation engine;
sending the computation task to a plaintext computation engine provided in the target data providing party for computation when the computation engine required for the computation task is the plaintext computation engine provided in the target data providing party;
sending the computation task to the plaintext computation engine and the ciphertext computation engine for computation and data interaction when computation engines required for the computation task are the plaintext computation engine provided in the target data providing party and the ciphertext computation engine; and
determining a computation result corresponding to the computation request based on a computation result corresponding to the computation engine required for the computation task, and sending the computation result corresponding to the computation request to the result demanding party.

10. The electronic equipment of claim 9, wherein, the step of parsing a computation task corresponding to the computation request, identifying a target data providing party involved in the computation task, and identifying a computation engine required for the computation task comprises the following steps:
determining a computational logic and a computational configuration based on the computation request; and
identifying, based on the computational logic and computational configuration, the computation task, the target data providing party involved in the computation task, and the computation engine required for the computation task.

11. The electronic equipment of claim 10, wherein, the step of identifying the computation task based on the computational logic and computational configuration comprises:
parsing based on the computational logic and the computational configuration to generate a computational graph, wherein, the computational graph comprises a node and an edge connecting the nodes, the node is corresponding to a variable in the computational logic, and the edge is corresponding to an operation in the computational logic; and
generating the computation task based on the computational graph.

12. The electronic equipment of claim 10, wherein, the computational configuration contains a data providing party ID involved in the computation task, and the step of identifying a target data providing party involved in the computation task and identifying a computation engine required for the computation task comprises:
in the case that the computational configuration contains one data providing party ID, identifying the target data providing party according to the data providing party ID, and identifying that the computation engine required for the computation task is a local plaintext computation engine of the target data providing party; and
in the case that the computational configuration contains a plurality of data providing party IDs, identifying a plurality of target data providing parties according to the data providing party IDs, and identifying the computation engine required for the computation task according to the computational logic.

13. The electronic equipment of claim 12, wherein, the step of identifying the computation engine required for the computation task according to the computational logic comprises:
if determining, based on the computational logic, that an operation involved in the computation task is for data of a single target data providing party, identifying that the computation engine required for the computation task is the plaintext computation engine; if not, identifying that the computation engine required for the computation task is the ciphertext computation engine.

14. The electronic equipment of claim 11, wherein, an input parameter for each group of computation in the computational logic has a preset identification, and the preset identification comprises a plaintext identification or a ciphertext identification;
the method further comprises:
adding the plaintext identification to corresponding node in the computational graph based on the plaintext identification of the input parameter for each group of computation, and adding the ciphertext identification to corresponding node in the computational graph based on the ciphertext identification of the input parameter for each group of computation;
the step of generating the computation task based on the computational graph comprises:
determining the computation task based on the preset identification of the node and an edge associated with the node in the computational graph, wherein the computation task comprises: a plaintext computation task and/or a ciphertext computation task;
the step of identifying the computation engine required for the computation task comprises:
in the case that the computation task comprises the plaintext computation task, identifying that the computation engine required for the computation task is the plaintext computation engine;
in the case that the computation task comprises the ciphertext computation task, identifying that the computation engine required for the computation task is the ciphertext computation engine; and
in the case that the computation task comprises the plaintext computation task and the ciphertext computation task, identifying that the computation engines required for the computation task are the plaintext computation engine and the ciphertext computation engine.
